(19) United States
(12) Patent Application Publication
(10) Pub. No.: US 2017/0101894 A1
(43) Pub. Date: Apr. 13, 2017

(54) ANGLED IMPINGEMENT INSERT WITH DISCRETE COOLING FEATURES

(71) Applicant: General Electric Company, Schenectady, NY (US)

(72) Inventors: Phebe Helena PREETHI, West Chester, OH (US); William Thomas BENNETT, West Chester, OH (US); John Howard STARKWEATHER, Cincinnati, OH (US); Timothy Deryck STONE, West Chester, OH (US)

(21) Appl. No.: 15/314,487

(22) PCT Filed: May 27, 2015
(86) PCT No.: PCT/US2015/032592

§ 371 Date: Nov. 28, 2016

Related U.S. Application Data
(60) Provisional application No. 62/004,685, filed on May 29, 2014.

(51) Int. Cl. F01D 25/12; F02C 7/12; F23R 3/00; F01D 9/04; F01D 11/08

(52) U.S. Cl. CPC F01D 25/12; F01D 9/041; F01D 11/08; F23R 3/002; F02C 7/12; F05D 2260/201; F05D 2260/202; F05D 2260/22141; F05D 2240/35; F05D 2220/32

(57) ABSTRACT

An engine component assembly is provided for impingement cooling including discrete cooling features. An insert is located opposite and adjacent to a cooled surface of the engine component and includes a plurality of angled impingement air holes. A cooling fluid flow path is flowing on one side the cooled surface of the engine component and adjacent to the insert and passes through the angled cooling holes of the insert in order to cool the cooled surface of the engine component. Additionally, a plurality of discrete cooling features may be located along the cooled surface of the engine component opposite the plurality of cooling holes in the insert.

### BACKGROUND

The technology described herein relates to angled impingement openings for reducing or mitigating particulate accumulation.

Most operating environments of a gas turbine engine receive particulate material into the engine. Such particulate can have various detrimental effects in the engine.

The accumulation of dust, dirt or other particulate matter in gas turbine engines or turbo-machinery reduces the efficiency of the machinery, as well as reducing the effectiveness of the cooling which occurs within the engine. The particulate may insulate components of the engine which lead to the increasing component temperature therein. Particulate can also block or plug apertures utilized for cooling components within the engine which further leads to decreased functionality or effectiveness of the cooling circuits within the engine components or hardware.

Accumulation of particulate is in part due to stagnation and/or recirculation of air flow within cooling circuits. Prior efforts to resolve particulate accumulation problems have included additional flow through the engine components so as to increase surface cooling. This has deemphasized internal cooling feature effectiveness but utilizes more compressed air which would alternatively be directed into the core for improving performance and output of the gas turbine engine.

It would be desirable to reduce or eliminate the factors leading to the increased temperature or decreased cooling effectiveness of the engine components. It would further be desirable to decrease the amount of particulate accumulation and decrease stagnation or low momentum of air flow so that particulate does not accumulate in the aircraft engine.

The information included in this Background section of the specification, including any references cited herein and any description or discussion thereof, is included for technical reference purposes only and is not to be regarded subject matter by which the scope of the invention is to be bound.

### SUMMARY

According to some embodiments, an engine component assembly is provided for impingement cooling including discrete cooling features. The engine component, for non-limiting example may be a turbine shroud or a nozzle airfoil which may be also located in a turbine or other parts of the engine. An insert is located opposite and adjacent to a cooled surface of the engine component and includes a plurality of angled impingement air holes. A cooling fluid flow path is flowing on one side the cooling surface of the engine component and adjacent to the insert and passes through the angled cooling holes of the insert in order to cool the cooled surface of the engine component. Additionally, a plurality of discrete cooling features may be located along the cooling surface of the engine component opposite the plurality of cooling holes in the insert.

According to some other embodiments, an engine component assembly for impingement cooling, comprises an engine component having a cooled surface, the engine component having a cooling flow path on one side of the cooled surface, an insert adjacent to the engine component cooled surface, the insert having a plurality of openings forming an array through the insert, the cooling flow path passing through the plurality of openings to cool the cooled surface, the openings extending through the insert at a non-orthogonal angle to a surface of the insert and, a plurality of discrete cooling features disposed along the cooled surface of the engine component, the cooling features facing the plurality of openings.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention is provided in the following written description of various embodiments of the invention, illustrated in the accompanying drawings, and defined in the appended claims.

### BRIEF DESCRIPTION OF THE ILLUSTRATIONS

The above-mentioned and other features and advantages of these exemplary embodiments, and the manner of attaining them, will become more apparent and the methods and structures for forming a gas turbine engine component assembly for impingement cooling with discrete cooling features will be better understood by reference to the following description of embodiments taken in conjunction with the accompanying drawings, wherein:

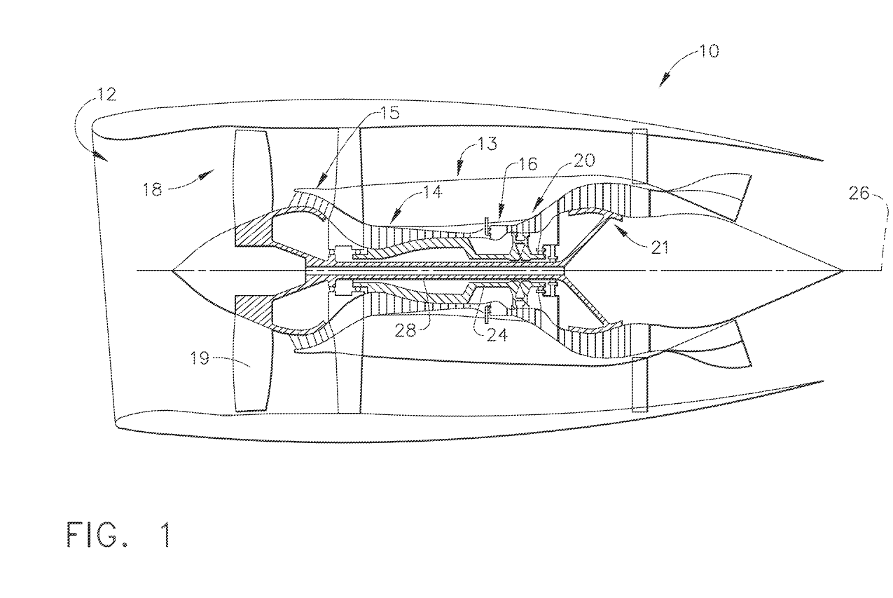

FIG. 1 is a side section view of an exemplary gas turbine engine;

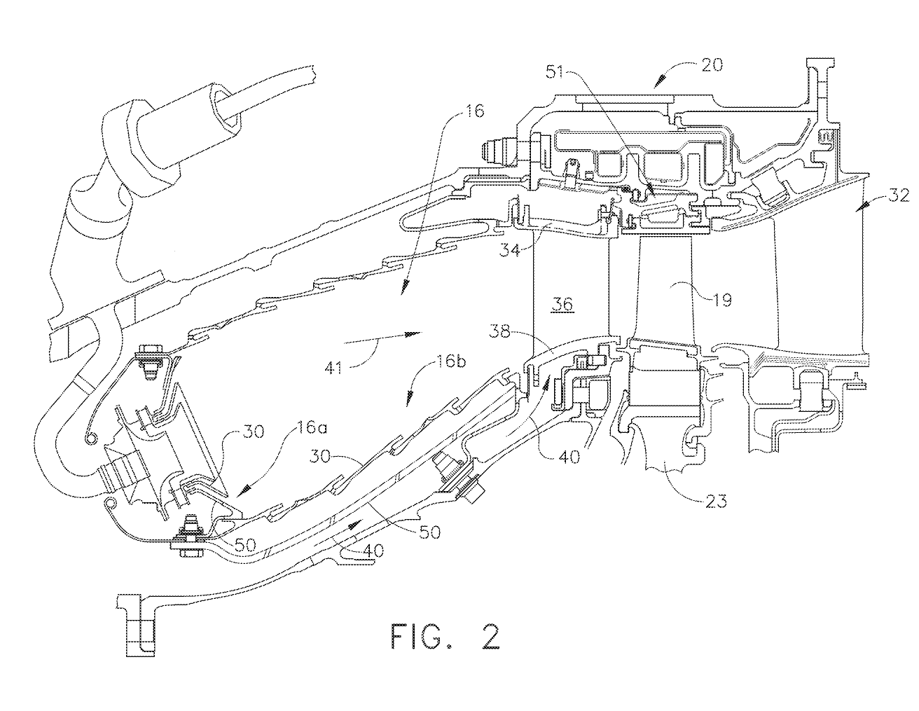

FIG. 2 is a side section view of a portion of the propulsor including a turbine and combustor;

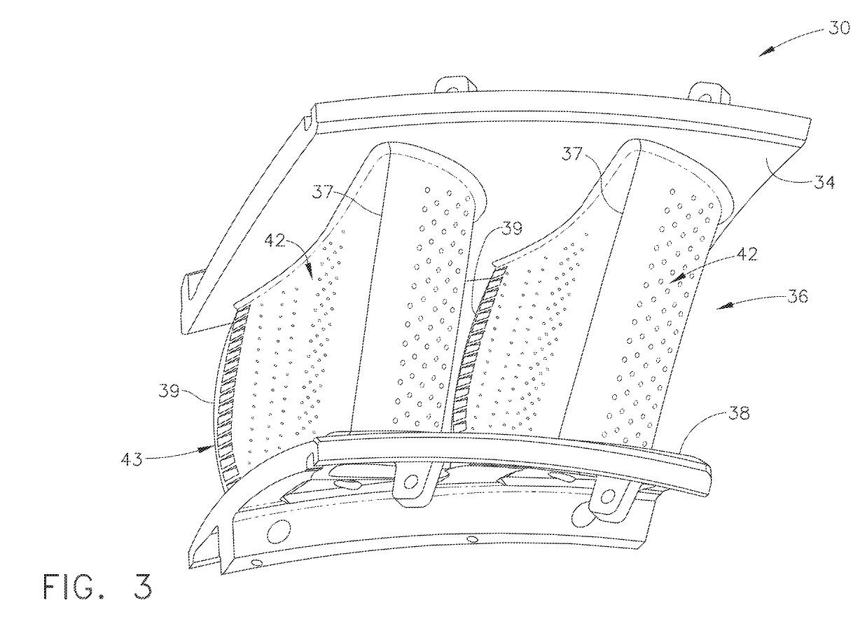

FIG. 3 is an isometric view of an exemplary nozzle utilized in the turbine;

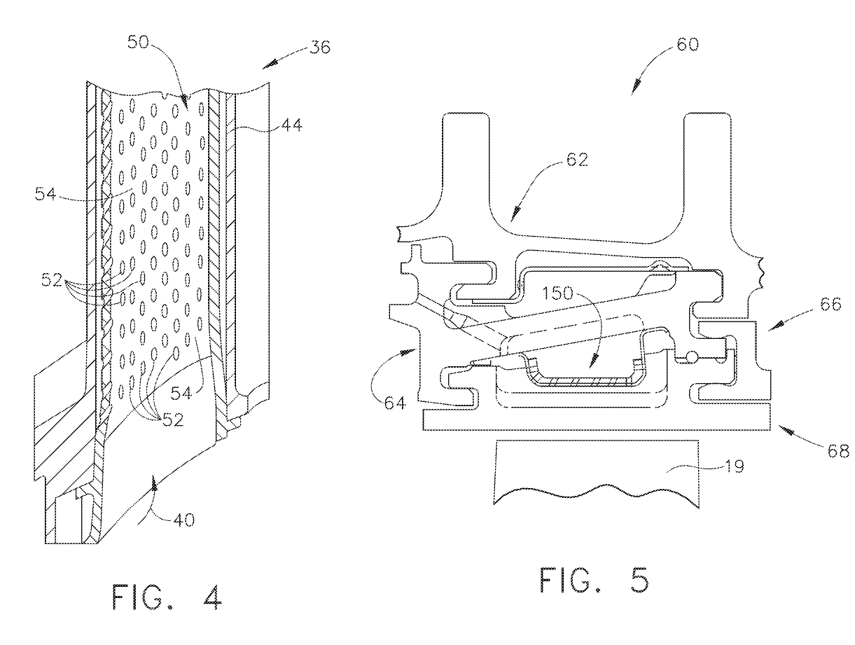

FIG. 4 is a partial section view of an exemplary nozzle;

FIG. 5 is a side section view of an alternative embodiment of the angled impingement structure;

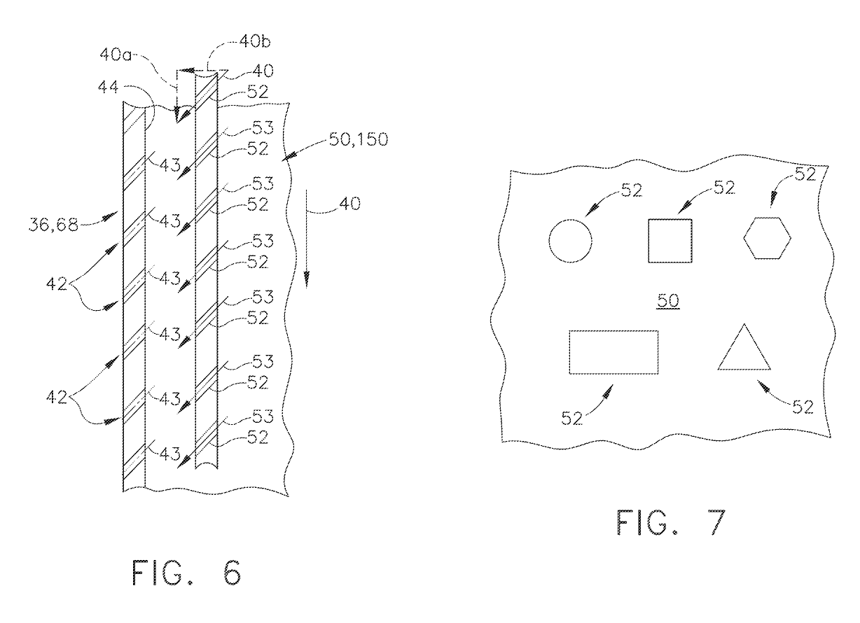

FIG. 6 is a schematic view of the angle impingement of a second component on a first component;

FIG. 7 is a view of various cross-sections of cooling hole openings which may be used with instant embodiments;

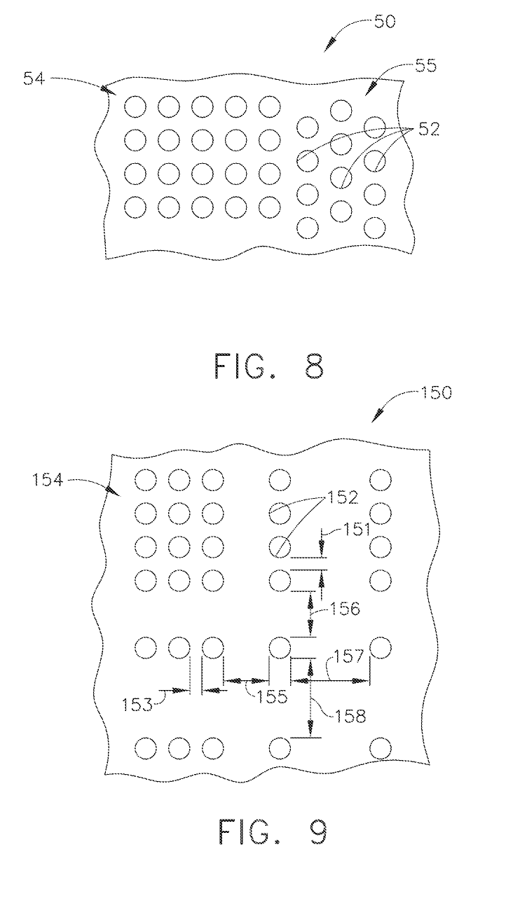

FIG. 8 is a view of an array including uniformly spaced apertures which may or may not be staggered; and,

FIG. 9 is a view of an array including non-uniformly spaced apertures.

FIG. 10 is a schematic view of an exemplary plurality of angled cooling apertures of an insert; and,

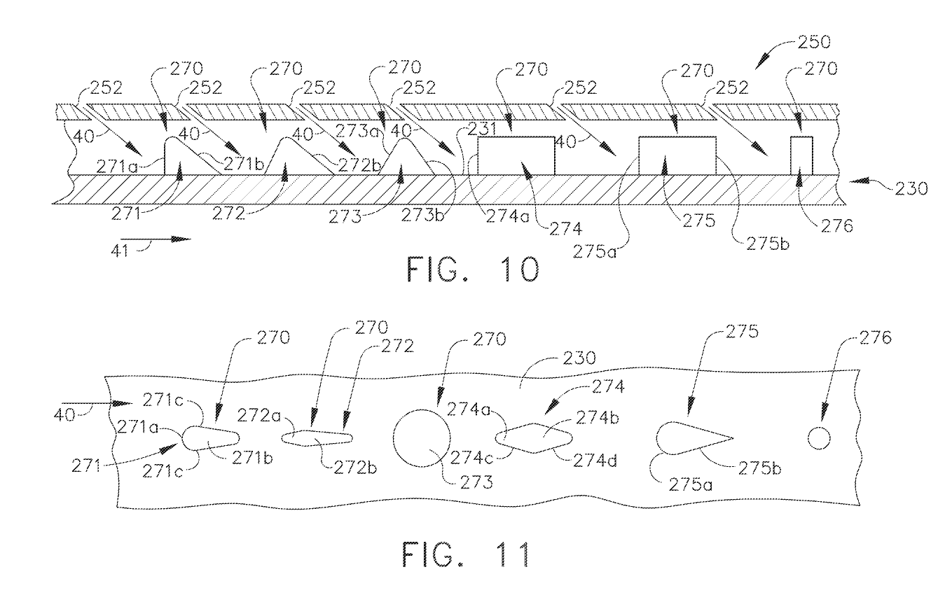

FIG. 11 is a top view of the plurality of cooling features;

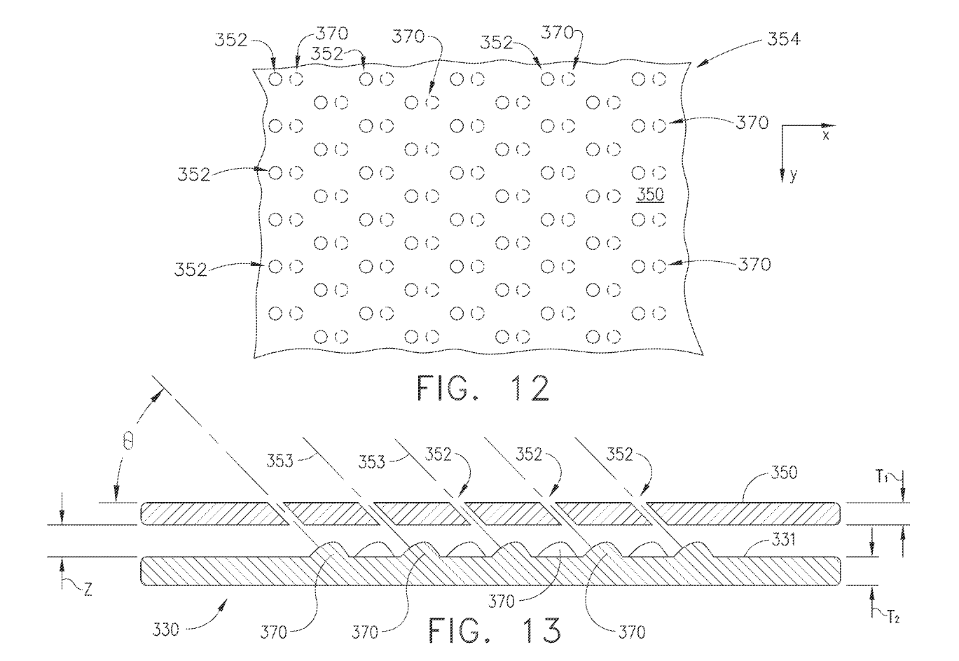

FIG. 12 is a top view of an array of uniform spacing with cooling apertures impinging upon the cooling features;

FIG. 13 is a side section view of the embodiment of FIG. 12;

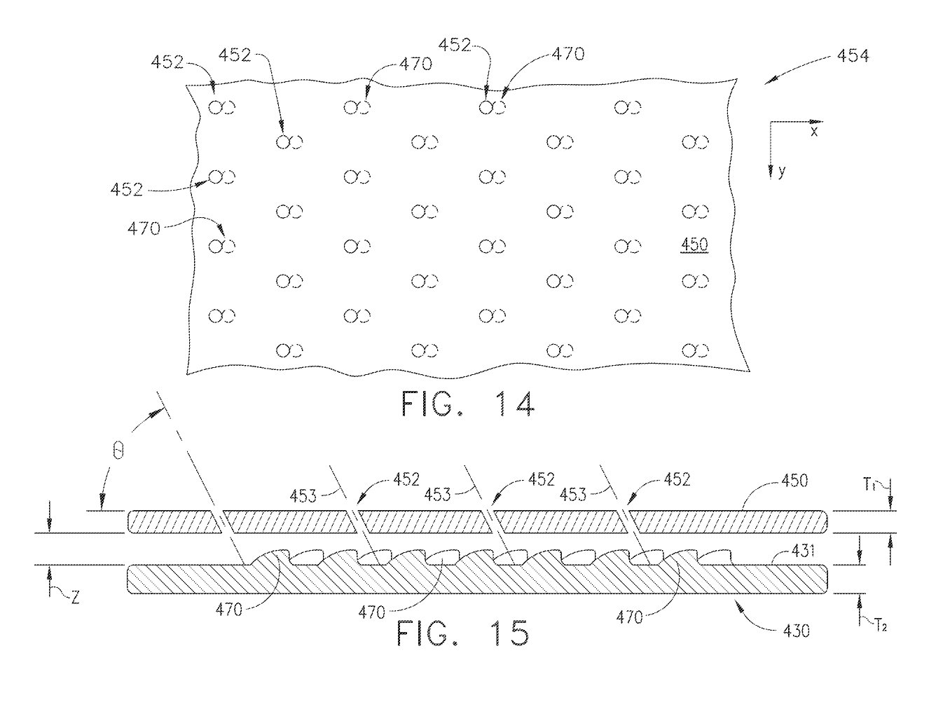

FIG. 14 is a top view of an alternate array having uniform spacing and cooling apertures impinging upon the cooled surface of the engine component; and,

FIG. 15 is a side section view of the embodiment of FIG. 14.

### DETAILED DESCRIPTION

Reference now will be made in detail to embodiments provided, one or more examples of which are illustrated in the drawings. Each example is provided by way of explanation, not limitation of the disclosed embodiments. In fact, it will be apparent to those skilled in the art that various modifications and variations can be made in the present embodiments without departing from the scope or spirit of the disclosure. For instance, features illustrated or described as part of one embodiment can be used with another embodiment to still yield further embodiments. Thus it is intended that the present invention covers such modifications and variations as come within the scope of the appended claims and their equivalents.

Referring now to FIGS. 1-15, various views are depicted which teach impingement inserts which reduce stagnation regions and therefore, particulate accumulation or build-up within an engine component. As a result, engine cooling may be improved. Present embodiments relate to gas turbine engine components which utilize an insert to provide cooling air along a cooled surface of an engine component. The insert provides an array of cooling holes or apertures which are facing the cooled surface of the engine component and direct cooling air onto that cool side surface. The apertures may be formed in arrays and are directed at an oblique angle or a non-orthogonal angle to the surface of the insert and further may be at an angle to the surface of the engine component being cooled. As a result, particulate accumulation within the engine component may be reduced. The present embodiments may be applied to first stage and second stage nozzles for example, as well as shroud hanger assemblies or other components or combinations that utilize impingement cooling and/or are susceptible to particulate build-up resulting in reduced cooling capacity, including but not limited to combustor liners, combustor deflectors and transition pieces. On a cooled surface of the engine component opposite the cooling holes may be a plurality of discrete cooling features. The cooling features may extend from the surface of the engine component or be formed in the surface of the cooling features. Various combinations of the depicted embodiments may be utilized to form the particulate accumulation mitigation features described further herein.

As used herein, the terms “axial” or “axially” refer to a dimension along a longitudinal axis of an engine. The term “forward” used in conjunction with “axial” or “axially” refers to moving in a direction toward the engine inlet, or a component being relatively closer to the engine inlet as compared to another component. The term “aft” used in conjunction with “axial” or “axially” refers to a direction toward the rear or outlet of the engine relative to the engine center line.

As used herein, the terms “radial” or “radially” refer to a dimension extending between a center longitudinal axis of the engine and an outer engine circumference. The use of the terms “proximal” or “proximally,” either by themselves or in conjunction with the terms “radial” or “radially,” refers to moving in a direction toward the center longitudinal axis, or a component being relatively closer to the center longitudinal axis as compared to another component. The use of the terms “distal” or “distally,” either by themselves or in conjunction with the terms “radial” or “radially,” refers to moving in a direction toward the outer engine circumference, or a component being relatively closer to the outer engine circumference as compared to another component.

As used herein, the terms “lateral” or “laterally” refer to a dimension that is perpendicular to both the axial and radial dimensions.

All directional references (e.g., radial, axial, proximal, distal, upper, lower, upward, downward, left, right, lateral, front, back, top, bottom, above, below, vertical, horizontal, clockwise, counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

Referring initially to FIG. 1, a schematic side section view of a gas turbine engine 10 is shown having an engine inlet end 12 wherein air enters a propulsor 13, which is defined generally by a multi-stage compressor, including for example a low pressure compressor 15 and a high pressure compressor 14, a combustor 16 and a multi-stage turbine, including for example a high pressure turbine 20 and a low pressure turbine 21. Collectively, the propulsor 13 provides power during operation. The gas turbine engine 10 may be used for aviation, power generation, industrial, marine service or the like. The gas turbine engine 10 is axis-symmetrical about engine axis 26 so that various engine components rotate thereabout. In operation air enters through the air inlet end 12 of the engine 10 and moves through at least one stage of compression where the air pressure is increased and directed to the combustor 16. The compressed air is mixed with fuel and burned providing the hot combustion gas which exits the combustor 16 toward the high pressure turbine 20. At the high pressure turbine 20, energy is extracted from the hot combustion gas causing rotation of turbine blades which in turn cause rotation of a shaft 24.

The engine 10 includes two shafts 24, 28. The axis-symmetrical shaft 24 extends through the turbine engine 10, from the forward end to an aft end for rotation of one or more high pressure compressor stages 14. The shaft 24 is supported by bearings along its length. The shaft 24 may be hollow to allow rotation of the second shaft 28, a low pressure turbine shaft therein. The shaft 28 extends between the low pressure turbine 21 and a low pressure compressor 15. Both shafts 24, 28 may rotate about the centerline axis 26 of the engine. During operation the shafts 24, 28 rotate along with other structures connected to the shafts such as the rotor assemblies of the turbine 20, 21, compressor 14, 15 and fan 18 in order to create power or thrust depending on the area of use, for example power, industrial or aviation.

Referring still to FIG. 1, the inlet 12 includes a turbofan 18 which includes a circumferential array of exemplary blades 19 extending radially outward from the root. The turbofan 18 is operably connected by the shaft 28 to the low pressure turbine 21 and creates thrust for the turbine engine 10.

Within the turbine areas 20, 21 are airfoils which are exposed to extremely high temperature operating conditions. It is desirable to increase temperatures in these areas of the gas turbine engine as it is believed such increase results in higher operating efficiency. However, this desire to operate at high temperatures is bounded by material limitations in this area of the engine. Turbine components are cooled to manage these material limits. For example, shrouds adjacent to rotating blades of the turbine or compressor may require cooling. Additionally, nozzles which are axially adjacent to the rotating blades may also require cooling. Still further, the combustor structures which hold the flame and combustion product gases may be cooled with impingement cooling. These components are collectively referred to as first engine components.

Referring now to FIG. 2, a side section view of a combustor 16 and high pressure turbine 20 is depicted. The combustor 16 is shown having various locations wherein impingement embodiments may be utilized. For example, one skilled in the art will realize upon review of this disclosure that the impingement embodiments defined by first and second components may be used in the area of the deflector 16a or the combustor liner 16b.

The turbine 20 includes a number of blades 19 which are connected to a rotor disc 23 which rotates about the engine center line 26 (FIG. 1). Adjacent to the turbine blades 19 in the axial direction, the first engine component may be embodied by the first stage nozzle 30 which is adjacent to the rotating blade 19 of turbine 20. The turbine 20 further comprises a second stage nozzle 32 aft of the blade 19. The second stage nozzle 32 may also embody the first engine component 30 as described further herein. The nozzles 30, 32 turn combustion gas for delivery of the hot working fluid to the turbine to maximize work extracted by the turbine 20, 21. The nozzle 30 includes an outer band 34, an inner band 38 and an airfoil 36. A cooling flow circuit or flow path 40 passes through the airfoil 36 to cool the airfoil as combustion gas 41 passes along the exterior of the nozzle 30. One area within a gas turbine engine where particulate accumulation occurs is within the nozzle 30, 32 of the turbine 20. The internal cooling circuit 40 which reduces temperature of the components can accumulate particulate and decrease cooling. The exemplary nozzle 32 may acquire particulate accumulation and therefore mitigation features described further herein may be utilized in a high pressure turbine stage one nozzle 30 or stage two nozzle 32. However, this is non-limiting and the features described may be utilized in other locations as will be discussed further. Additionally, as described further, shroud assembly 51 may require cooling due to the turbine operating conditions.

Referring now to FIG. 3, an isometric view of an exemplary nozzle 30 is depicted. The nozzle includes the outer band 34 and the inner band 38, between which an airfoil 36 is located. The airfoil 36 may be completely or at least partially hollow and provide the air flow path or circuit 40 (FIG. 2) through such hollow portion of the airfoil. The airfoil 36 includes a leading edge 37, a trailing edge 39 and a radially outer end and radially inner end. The outer surface of the nozzle receives combustion gas 41 (FIG. 2) from the combustor 16 (FIG. 1). The inner surface of the airfoil 36 is cooled by the cooling flow path 40 to maintain structural integrity of the nozzle 30 which may otherwise be compromised by the high heat in the turbine 20. The outer band 34 and inner band 38 are located at the outer end and inner end of the airfoil, respectively.

The exterior of the airfoils 36 may be formed with a plurality of cooling film holes 42 which form a cooling film over some or all of the airfoil 36. Additionally, the airfoil 36 may include apertures 43 at the trailing edge 39.

Referring now to FIG. 4, a partial section view of the nozzle 30 is depicted through a radial section to depict the interior area of the airfoil 36. In this view, the inner or cooling surface of the airfoil 36 is shown. The inner surface 44 is disposed adjacent to the cooling flow path 40. As used with respect to the cooling flow path, the term “adjacent” may mean directly near to or indirectly near to. Within the airfoil 36 is a second engine component 50, for example an insert, which receives air flow 40 through the hollow space of the airfoil 36 and directs the air flow outwardly to an interior surface of the airfoil 36. An insert 50 may be inserted inside another component, or being inserted between two parts. The insert 50 is made with multiple cooling holes or apertures 52 that allow fluid to flow through the insert 50. Further, the inserts 50 may be generally sealed around a perimeter to the part being cooled, and therefore, all of the fluid flows through the holes and none goes around the insert. Alternatively, the insert 50 may not be completely sealed and therefore allows some preselected amount of cooling flow path 40 air to bypass the impingement holes 52. The insert flow area and pressure ratio is such that the fluid is accelerated through each impingement cooling hole or aperture 52 to form a cooling impingement jet. The insert 50 is disposed adjacent to the cooling flow path 40, between the cooling flow path and the interior airfoil surface 44 according to one embodiment. The insert 50 includes a plurality of cooling holes or openings 52. The insert 50 directs such cooling air to the airfoil 36 by way of the plurality of openings or cooling holes 52 located within the insert 50. The openings 52 define at least one array 54. The term “array” is utilized to include a plurality of openings which may be spaced both uniformly from one another and non-uniformly at varying distances. An array 54 of holes or apertures formed in an insert 50 is present if in at least the two-dimensional case, e.g. a plane, it requires both X and Y coordinates in a Cartesian system to fully define and locate the hole placements with respect to one another. Thus, an array requires the relative spacings in both dimensions X and Y. This plane example could then be understood as applying also to curved inserts as the array is located on the surface curvature. A grouping of holes or apertures would then comprise any array or a portion of an array, especially if the spacings, hole diameters, orientations, and angles are changing from one hole to another, from one row of holes to another, or even from one group of holes to another. A pattern ensues when the same qualifiers are repeated over a number of holes, rows, or groups. Additionally, the arrays 54 may be arranged in groups or patterns wherein the patterns are either uniformly spaced or non-uniformly spaced apart.

Each of the openings 52 extends through the insert 50 at a preselected angle. The angle of each cooling opening may be the same or may vary and may further be within a preselected range as opposed to a specific angle. For example, the angle may be less than 90 degrees. The openings may be in the same or differing directions. The insert 50 directs the cooling air to the cold surface of the airfoil 36, that is the interior surface 44 for example, which is opposite the combustion gas or high temperature gas path 41 traveling along the exterior of the nozzle 30 and airfoil 36.

Further, the apertures 52 may be formed in a plurality of shapes and sizes. For example any or various closed boundary shapes may be utilized, including but not limited to circular, oblong, polygon, By polygon, any shape having at least three sides and three angles may be utilized. Further, the angles may include radiuses or fillets. According to some embodiments, the apertures are all of a single size. According to other embodiments, the apertures 52 may be of differing sizes. Further, the cross-sectional shapes of the apertures may all be of a single shape or vary in shape. As shown in FIG. 7, a plurality of cross-sectional shapes are shown as exemplary apertures 52 which may be utilized. The sizes and shapes may be tuned to provide the desired cooling or the desired air flow usage through the insert to the inside or cold surface of the airfoil. By tuned, it is meant that the sizes and/or shapes may be varied to obtain a desired cooling and/or reduction of particulate build up.

According to the embodiments shown in FIG. 5, an alternate utilization of the exemplary particulate mitigation structure is provided. According to this exemplary embodiment, a shroud hanger assembly 60 is shown having an interior insert 150 which cools a cold side of a shroud by way of impingement cooling. The shroud hanger assembly 60 comprises a hanger 62 that includes a first hanger portion 64 and a second hanger portion 66. The hanger portions 64, 66 retain a shroud 150 in position, adjacent to which a blade 19 rotates. It is desirable to utilize cooling fluid moving within or defining the cooling flow path or circuit to reduce the temperature of the insert 150 by way of impingement cooling. However, it is known for prior art shroud hanger assemblies to incur particulate accumulation within this insert area and on the cooling surface of the shroud 68 which over time, reduces cooling capacity of the cooling fluid. According to the instant embodiments, the insert 150 may include the plurality of apertures which are angled or non-orthogonal to the surface of the insert and surface of the shroud. In this embodiment, the array 54 of apertures 52 are angled relative to the surface of the insert and the opposite surface of the shroud to limit particulate accumulation in this area of the gas turbine engine.

Referring now to FIG. 6, a schematic view of the angled impingement configuration is depicted. The first engine component 30 may be the airfoil nozzle 36 or shroud 68 according to some embodiments. The insert 50, 150 may be the second engine component. The angle of the aperture 52 is defined by an axis 53 extending through the aperture 52. The axis 53 may be angled with the inner or cooled surface 44 or may be aligned or may be unaligned with film holes 42. The holes 42 and cooling aperture 52 may be aligned where the axis 53 of the cooling aperture passes through the cooling film hole 42 or crosses the axis 43 of the cooling film hole at or near the cooling film hole. Alternatively, the axis 53 may not be aligned with the cooling holes 42 so as to impinge the surface 44.

Additionally shown in this view, the relationship of aperture length to diameter ratio may be discussed. The insert 50 may have thickness generally in a horizontal direction for purpose of the description and exemplary depiction. It has been determined that increasing the thickness of the insert may improve the desirable aperture length-to-diameter ratio which will improve performance. Conventional inserts have aperture length-to-diameter ratios generally of less than 1. For the purpose of generating and forming a fluid jet that has a well-defined core region with minimal lateral spreading, the length-to-diameter ratios of angled apertures are desired to be in the range of 1 to 10, and more specifically in the range of 1 to 5. To comply with other desirable engine metrics such as weight and aperture, length-to-diameter ratios in the range of 1 to 2.5 are frequently more desirable. The length that is used in this length-to-diameter ratio is defined as the portion of the aperture centerline axis that maintains a complete perimeter for the cross section taken perpendicular to the axis. Further, the thickness of the insert 50 may be constant or may vary. Still further, it will be understood by one skilled in the art that the aperture cross section may change in area as a function of its length while keeping the same basic shape, i.e. it may expand or contract. Accordingly, the aperture axis may define a somewhat or slightly arcuate line, not necessarily a perfectly straight line.

The cooling fluid or cooling air flow 40 is shown on a side of the airfoil 36 and also adjacent to the insert 50, 150. The insert 50 includes an array defined by the plurality of apertures 52 located in the insert and which direct the air outwardly at an angle relative to the inside surface of the component 50, 150. The nozzle 30 may also comprise a plurality of cooling holes 42 which may be at an angle to the surface as depicted but may be at any angle to the nozzle surface. With this embodiment, as with the previous embodiment, the array of cooling openings may be of various sizes and shapes wherein the apertures may be uniformly spaced or may be non-uniformly spaced and further wherein the pattern or arrays may be uniformly spaced or non-uniformly spaced apart. The cooling apertures 52 may also be of one uniform cross-sectional shape or of varying cross-sectional shapes and further, may be of uniform size or varying size or formed in a range of sizes.

Also shown in FIG. 6, is the passage of the cooling air 40 through one of the apertures 52. This is shown only at one location for sake of clarity. The flow of cooling fluid 40 is made up of two components. The first axial component 40a may be an average fluid velocity tangent to the cooled surface 44. The second radial component 40b may be an average fluid velocity normal to the cooled surface 44. These two components 40a, 40b are not shown to scale but define the vector of the cooling fluid 40 exiting the cooling apertures 52. The components 40a, 40b may also define a ratio which may be between 0 and 2. According to some embodiments, the ratio may be between 0.3 and 1.5. According to still further embodiments, the ration may be between 0.5 and 1.

Additionally, it should be understood by one skilled in the art that the cooling apertures 52, 152 or others described may be aimed in three dimensions although only shown in the two dimensional figures. For example, a cooling aperture 52 or any other embodiment in the disclosure may have an axis 53 which generally represents the cooling flow 40 passing through the aperture. The axis 53 or vector of the cooling flow 40 through the aperture 52 may be defined by at least two components, for example a radial component (40b) and at least one of a circumferential or axial component (40a). The vector may be aimed additionally by varying direction through the third dimension, that is the other of the circumferential or axial dimension, some preselected angular distance in order to provide aiming at a desired location on the surface of the opposed engine component, or a specific cooling feature as discussed further herein. In the depicted embodiment, the third dimension, for example the circumferential dimension, may be into or out of the page, for example.

Referring now to FIG. 8, a view of an exemplary second component surface is depicted, for example component 50 or 150. The surface includes an array 54 of apertures 52. The array 54 may be formed of rows of apertures 52 extending in first and second directions. According to one embodiment, the array 54 is shown having a uniform spacing of apertures 52. The apertures 52 in one direction, for example, the left to right direction shown, may be aligned or alternatively may be staggered so that holes in every other row are aligned. The staggering may occur in a second direction, such as a direction perpendicular to the first direction. A plurality of these arrays 54 may be utilized on the insert 50 or a mixture of arrays 54 with uniform size and/or shape may be utilized. A single array may be formed or alternatively, or a plurality of smaller arrays may be utilized along the part. In the instant embodiment, one array 54 is shown with uniform spacing and hole size and shape, on the left side of the figure. On the right side of the figure a second array 55 is shown with apertures 52 of uniform spacing, size and shape, but the rows defining the array 55 are staggered or offset.

With reference to FIG. 9, a plurality of arrays is again shown. However, in this embodiment the arrays 154 are non-uniformly spaced apart and additionally, the apertures 52 may be non-uniformly spaced apart. Such spacing may be dependent upon locations where cooling is more desirable as opposed to utilizing a uniformly spaced array which provides generally equivalent cooling at all locations.

The array 154 has a first plurality of apertures 152 which are spaced apart a first distance 153. The apertures 152 are additionally shown spaced apart a second distance 155 which is greater than distance 153. The apertures 152 have a further spacing distance 157 which is greater than spacings 153 and 155. All of these spacings are in the first direction. Further the spacing of apertures 152 may vary in a second direction. For example, the apertures 152 are shown with a first spacing 151, 156 and 158 all of which differ and all of which therefore vary row spacing of the array 154.

Thus, one skilled in the art will appreciate that, regarding these embodiments, the arrays 154 of apertures 152 may be formed in uniform or non-uniform manner or a combination thereof. It should be understood that non-uniform apertures may form arrays which are arranged in generally uniform spacing. Similarly, the apertures may be uniformly spaced and define arrays which are non-uniform in spacing. Therefore, the spacing of apertures and arrays may or may not be mutually exclusive. Still further, the apertures 152 may be formed of same or varying sizes and cross-sectional areas as previously described.

Referring now to FIG. 10, a side schematic view of an exemplary construction is provided including a first engine component 230 and a second engine component 250. The first engine component 230 may be for non-limiting example a nozzle, a shroud, a combustor liner, combustor deflector or other transition pieces as with previous non-limiting embodiments. The second engine component 250 may be an insert which includes a plurality of impingement cooling holes 252 including any of the previous embodiments or combinations of the previous embodiments. The second engine component 250 is disposed adjacent to the first engine component 230, with a gap therebetween, and receives cooling flow path 40. The cooling fluid, for example compressed air, in the cooling air flow path 40 passes through the impingement cooling holes 252 to the first engine component 230.

The second engine component 250 is depicted in the exemplary schematic view as an upper horizontal structure in the figure and includes a plurality of angled cooling apertures 252 extending through the component 250. These may take any of the various forms as previously described as related to the individual holes 252 and as related to the groups of holes 252 and the component 250, for example insert, is not limited to a horizontal structure and is not limited to a flat plate form. Additionally, the second engine component 250 may not be limited to a constant thickness but instead, may vary thickness and may or may not be flat.

In the depicted embodiment, beneath the cooling apertures 252 and spaced opposite the first component 230, which may represent the insert, is the first component 230. A hot combustion gas path 41 is shown passing along a hot surface, for example the lower surface of component 230. The upper surface of the component 230 is a cooling surface 231 which is impingement cooled. The first engine component 230 includes a plurality of discrete cooling features 270 which extend from cooling surface 231 the first engine component 230 toward the second engine component 250. The discrete cooling features 270 may take various shapes, geometries, forms and various types are shown extending from the cooling surface 231 of the engine component 230 into the gap between engine components 230, 250. For example, the cooling features 270 may vary in width or have a constant width. Width is measured as the base dimension where the feature meets the surface 231 and height is measured as the centerline dimension of the generally symmetric feature shape from the base to the top of the feature. The width-to-height ratio may be in the range of about 1:1 to about 1:5. Further, the cooling features 270 may have a length wherein the length and height are substantially equal or not substantially equal. The length may be up to about 7 times the height according to some embodiments but may be of shorter length-to-height ratio. The side view may be polygon, cylindrical, triangular or other shapes, any of which may include sharp corners or alternatively, may have curved or radiused corners in order to improve aerodynamics. By polygon, it is meant that the cooling features 270 have at least three straight sides and angles as shown in side view. Similarly, fillets or corner radii may be utilized where the features 270 meet the component 230.

According to some embodiments, the features 270 extend from the engine component 230 toward the insert 250. Additionally, while the embodiments shown heretofore have been related primarily to nozzles and shrouds, it is within the scope of the instant disclosure that the structure may further comprise other engine components which are cooled by way of impingement cooling within a gas turbine engine.

Referring still to FIG. 10 and additionally to FIG. 11, which depicts a top view of the cooling features 270 of FIG. 10, the cooling feature 271 is first discussed. A plurality of cooling features 270 are shown along the engine component 230 and will be described from left to right. It should be understood that any of the following embodiments may be used together with similar fins or with other fins shown.

Referring to the left side of the component 230, the first embodiment cooling feature 271 is shown. The first cooling feature 271 is generally fin shaped. According to the first embodiment, the fin shaped feature 272 is generally triangular when shown in the side view of FIG. 10. The fin 271 has a substantially vertical forward edge 271a and tapers from an upper end downwardly to the engine component surface along surface 271b. The cooling feature or fin 271 may have one or more side walls 271c which may be straight, curved or taper from a wider forward end to a narrower aft end. Alternatively, the narrow end may be forward (to the left) and may widen moving aft (to the right) and may have tapers which are linear, curved or otherwise arcuate or curvilinear.

The feature 271 includes a semi-circular cross section at either or both of the forward end and the aft end, as shown in FIG. 11. The feature 271 has a forward end curvature with a radius dimension which is of a first radius and an aft end curvature with a second radius dimension wherein the first dimension is greater than the second dimension. This configuration provides the taper from the forward end to the aft end of the fin 271. The side walls 271c may be tapered to provide the feature 271 varying width and the desired aerodynamic effect for the cooling. Alternatively, to the semi-circular cross section, the forms may be elliptical or other arcuate shapes for this and all other embodiments.

In this embodiment, the impingement cooling fluid may be aimed to engage the cooling features 270, that is aligned with the cooling features 270. For example, the axis of the cooling holes 252 may be aligned with or intersect the feature 270. Alternatively, the impingement cooling fluid may be directed to an area between the features or staggered or offset from the feature 270 but instead, may impinge the surface 231 of the component. For example, the axis of cooling holes 252 may not intersect the cooling holes 252.

Referring again to FIG. 10, a second embodiment of the cooling feature 270 is shown in the form of feature or fin 272, wherein the forward wall 272a of the feature is angled rather than vertical. Again, the forward end and aft end include semi-circular cross-sections. The forward end of the fin 272 has a first radius. A second radius is located at an intermediate location. Subsequently, at the aft end the radius of the curvature is less than the intermediate location and may be the same or less than the forward wall as shown in FIG. 11. The top of the fin 272 has a first surface 272a which rises to the intermediate location and a second surface 272b which depends downwardly from the intermediate location which tapers to the aft end. The fin 272 also widens from the first end to the intermediate location and narrows from the intermediate location to the aft end. The side view of the discrete cooling feature shows that the fin 272 is also triangular shaped but does not have a forward wall which is vertical as in the first embodiment. The profile of the feature 272 is formed such that the forward surface 272a is generally less than the length of the aft surface 272b. In other words, the peak of the fin shaped feature 272 is closer to the forward end than the aft end.

Referring now to the third embodiment shown in FIG. 10, the discrete cooling feature 273 is generally conical in shape. In this embodiment, the side view of the fin 273 shows a substantially triangular shaped cooling feature wherein the peak of the fin shape is substantially centered. As a result, the forward wall 273a and aft wall 273b shown in the side view of FIG. 10 are generally of equal length as opposed to the first two embodiments previously described. As shown in the top view of FIG. 11, the cooling feature 273 is generally circular.

Referring now to the fourth embodiment of FIG. 10, the side view shows the feature 274 is generally rectangular shaped. The discrete cooling feature 274 is shown in FIG. 11 with a forward radius of a first size and an aft radius of substantially the same size. When viewed from above, in FIG. 11, the feature 274 is generally diamond shaped. The cooling feature or fin 274 has side walls 274a which increase in thickness from the forward to the middle location due to the radius of the cross-section at the central location, in the forward to aft (left to right) direction along the fin 274. Beyond the center location, the feature sidewall 274b decreases in thickness to a smaller radius size at the aft end of the feature 274, where the feature is narrow, as is the forward end. The cooling feature 274 also has side walls 274c which increase in thickness from the forward to the middle location due to the radius of the cross-section at the central location, in the forward to aft (left to right) direction along the feature 274. Beyond the center location, the feature sidewall 274d decreases in thickness to a smaller radius size at the aft end of the feature 274, where the feature is narrow, as is the forward end. The forward end and the aft end of the feature 274 extend vertically from the component 230. Thus, as compared to the second embodiment wherein the intermediate change in dimension occurred closer to the forward end of the fin and the aft end, the present embodiment has a central location where the fin has its widest location in the direction of flow 40. However, this is not limiting as the widest area need not be at the center. As shown in the side view of FIG. 10, the embodiment looks substantially rectangular in profile as the forward and aft walls are generally vertical. However, it is within the scope of the embodiment that the forward and aft walls be angled according to other embodiments described.

Referring to the fifth embodiment of FIG. 10, the side view shows a generally square or rectangular shaped discrete cooling feature or fin 275. The feature 275 has forward wall 275a which is substantially vertical as with the previous embodiment and the first embodiment. The first wall 275a has a radius dimension providing the round forward end of the feature 275. The feature 275 further comprises sidewalls 275b (FIG. 11) which taper back to an aft vertical wall. The aft end may be pointed rather than radiused as in previous embodiments. The embodiment is shown more clearly in FIG. 11 with the forward dimension of the cooling feature having a larger radius dimension which decreases down to a point at the aft end of the fin.

As shown in FIG. 10, the final embodiment is generally cylindrically shaped cooling feature 276 having a round cross-section. This embodiment may be defined as a pin structure rather than a fin shape. As previously discussed, these embodiments may be used together or a single embodiment may be utilized and spaced apart from one another. Additionally, other embodiments are possible wherein combinations of features of the various embodiments may be used to form additional discrete cooling features.

Referring again to FIG. 10, the cooling air flow 40 is depicted as arrows passing through the apertures 252. The aiming of the cooling apertures 252 may be discussed by the axis of the aperture which corresponds to the depicted arrows representing the air flow. The cooling features 270 may be oriented in at least two manners relative to the cooling holes 252. According to some embodiments, the features 270 are aligned with the cooling holes 252 wherein the axis of the cooling hole 252 intersects or impinges the feature 270. According to alternate embodiments, the features 270 are staggered relative to the cooling holes 252 and offset from direct alignment with the apertures 252. In this embodiment, the axis of the cooling holes 252 may not engage the feature 270 but instead may engage the surface 231 of component 230. Further, the features 270 may be spaced apart uniformly or may be spaced apart non-uniformly. Still further, the features 270 of the engine component 230 may define one or more patterns wherein the multiple patterns may be spaced apart in a uniform manner or may be spaced in a non-uniform manner in ways previously discussed with the cooling holes. Further, one skilled in the art should realize that this disclosure does not require a single feature 270 for each aperture 252. There may be more features 270 or more apertures 252.

In the embodiment, where the cooling features 270 are aligned with the cooling holes 252, the holes 252 may be positioned such that the cooling air 40 is aligned with the forward walls of the features 270. Alternatively, the cooling air 40 may be directed to engage the upper surfaces of the cooling targets. Still further, the cooling air 40 may engage alternate locations of the cooling features 270.

Referring now to FIG. 12, a top view of an embodiment is shown having various exemplary discussed features desired for use in exemplary components. In the top view, the arrangement of cooling apertures 352 are shown in an array 354 wherein the apertures 353 are aligned with the features 370. These features 370 are below the component 350 as indicated in FIG. 13, but are shown for purpose of illustration in this view. The array 354 is defined in this example by an x-axis of first rows and a y-axis of second rows. The array of apertures 352 is staggered meaning that immediately a first row, for example in the x-axis direction, is offset by some amount in the x-direction to the adjacent row in the x-direction. The same may be said for the rows of the y-direction. In this embodiment the spacing between apertures 352 is uniform but alternatively, may be non-uniform as previously described.

Referring now to FIG. 13, the side section view of FIG. 12 is shown. The apertures 352 are defined in part by axes 353 which also define a direction of flow of cooling fluid through apertures 352. As described, the features 370 are protruding from the first engine component 330.

According to the instant embodiment, the axis 353 of each of the cooling holes 352 depicts that the impingement point of the cooling flow 40 (indicated by axis 353) passing therethrough engages the cooling feature 370. This is due to the alignment in the x-direction (FIG. 12) with the aperture axes 353 for impingement of cooling fluid on the features 370. More specifically, the cooling flow 40 engages the forward edge or surface 331 of the feature 370 at the section cut depicted. However, alternative embodiments may provide that the features 370 are not aligned with the impingement apertures but instead are offset, for example in the y-direction (FIG. 12) relative to the apertures 352.

With regard now to FIG. 14, a top view of an alternate array 454 is shown. Again, the view depicts both the aperture 452 and the feature 470, which is actually beneath the depicted surface 450. The apertures 452 are formed in the array 454 which is of uniform spacing, although non-uniform spacing may be utilized. The rows are also staggered and are staggered in the x and y direction. Further however, other embodiments may have rows which are aligned rather than staggered as with the previous embodiment.

With reference now to FIG. 15, a side section view of the embodiment of FIG. 14 is shown. The array 454 includes apertures 452 located in the second component 450. An array is also provided of the cooling features 470 which protrude from the first component 430.

In this embodiment, the axes 453 show the direction of cooling flow for the cooling fluid 40 passing through the insert 450 toward the first engine component 430. In this embodiment, the impingement occurs between the cooling features 470 rather than on the cooling feature as with the embodiment of FIG. 13. As noted previously, the impingement on the surface 431 may also occur by offsetting the features 470 corresponding to an aperture 452 away from the aperture, for example in the y-direction. Additionally, the angle of the aperture axes 353 and 453 differ and may provide a further means of adjusting the impingement of the axes 353, 453 on or around the features 370, 470.

The foregoing description of structures and methods has been presented for purposes of illustration. It is not intended to be exhaustive or to limit the invention to the precise steps and/or forms disclosed, and obviously many modifications and variations are possible in light of the above teaching. Features described herein may be combined in any combination. Steps of a method described herein may be performed in any sequence that is physically possible. It is understood that while certain embodiments of methods and materials have been illustrated and described, it is not limited thereto and instead will only be limited by the claims, appended hereto.

While multiple inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Examples are used to disclose the embodiments, including the best mode, and also to enable any person skilled in the art to practice the apparatus and/or method, including making and using any devices or systems and performing any incorporated methods. These examples are not intended to be exhaustive or to limit the disclosure to the precise steps and/or forms disclosed, and many modifications and variations are possible in light of the above teaching. Features described herein may be combined in any combination. Steps of a method described herein may be performed in any sequence that is physically possible.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

What is claimed is:

1. An engine component assembly for impingement cooling, comprising:
an engine component having a cooled surface;
said engine component having a cooling fluid flow path on one side of said cooled surface;
an insert adjacent to said engine component cooled surface, said insert having a plurality of openings forming an array through said insert, said cooling fluid flow path passing through said plurality of openings to cool said cooled surface;
said openings extending through said insert at a non-orthogonal angle to a surface of said insert; and,
a plurality of discrete cooling features disposed along said cooled surface of said engine component, said cooling features facing said plurality of openings.

2. The engine component assembly of claim 1, said plurality of discrete features being a plurality of fins.

3. The engine component assembly of claim 2 wherein each of said plurality of fins have one of constant or varying width.

4. The engine component assembly of claim 3, said plurality of fins forming an array.

5. The engine component assembly of claim 2, said fins having a height and a length which are substantially equal.

6. The engine component assembly of claim 2, said fins having a height and a length which differ.

7. The engine component assembly of claim 1, said plurality of discrete cooling features having a polygonal shape in side view.

8. The engine component assembly of claim 7, said plurality of discrete cooling features being one of triangular, square or rectangular.

9. The engine component assembly of claim 1, wherein said plurality of discrete cooling features may be tuned to improve the flow characteristics.

10. The engine component assembly of claim 1, said cooling features being aligned with said plurality of openings.

11. The engine component assembly of claim 10, said cooling features being aligned with one another in one row.

12. The engine component assembly of claim 10, said cooling features being aligned with one another in at least two rows.

13. The engine component assembly of claim 11, said cooling features being one of aligned or offset from said plurality of openings along a direction of said cooling fluid flow path.

14. The engine component assembly of claim 1, said engine component being a combustor.

15. The engine component assembly of claim 14, said engine component being one of a combustor liner or a combustor deflector.

16. The engine component assembly of claim 15, said cooling fluid flow path passing through said openings of said insert cooling said combustor liner.

17. The engine component assembly of claim 1, said engine component being an airfoil.

18. The engine component assembly of claim 17, said airfoil being on a nozzle vane.

19. The engine component assembly of claim 1, said engine component being a shroud.

20. An engine component assembly for impingement cooling, comprising:
an engine component having a cooled surface;
said engine component having a cooling fluid flow path on one side of said cooled surface;
an insert adjacent to said engine component cooled surface, said insert having a plurality of openings forming an array through said insert, said cooling fluid flow path passing through said plurality of openings to cool said cooled surface;
said openings extending through said insert at a non-orthogonal angle to a surface of said insert;
a plurality of discrete cooling features disposed along said cooled surface of said engine component, said cooling features facing said plurality of openings; and
said engine component having a plurality of cooling film holes disposed over at least a portion of an outer surface of said engine component.
